(19) United States
(12) Patent Application Publication
(10) Pub. No.: US 2018/0332690 A1
(43) Pub. Date: Nov. 15, 2018

(54) APPARATUS AND METHOD FOR RESETTING A NON-POWERED ELECTRONIC DEVICE

(71) Applicant: PHILIPS LIGHTING HOLDING B.V., AE Eindhoven (NL)

(72) Inventors: JOHANNES GERRIT JAN BEIJER, BAVEL (NL); LUCAS LOUIS MARIE VOGELS, HERTEN (NL); HICHAM SABIR, EINDHOVEN (NL)

(21) Appl. No.: 15/527,879

(22) PCT Filed: Nov. 13, 2015
(86) PCT No.: PCT/EP2015/076591

§ 371 Date: May 18, 2017

(30) Foreign Application Priority Data
Nov. 18, 2014 (EP) 14193699.7

(51) Int. Cl. H05B 37/02

(52) U.S. Cl. CPC H05B 37/0272

(57) ABSTRACT

The present invention relates to a method and an apparatus for resetting an electronic device using a bi-stable element that can be set into a first state by means of electronic control and into a second state by means of a mechanical movement while the electronic device is in a non-powered state. Thus, after power off, the mechanical movement can be used to reset the bi-stable element into the second state which may open the electronic device for commissioning in a network.

### FIELD OF THE INVENTION

The invention relates to the field of an apparatus and method for resetting a device, such as—but not limited to—a wireless electronic device which can be commissioned to a network for remote control.

### BACKGROUND OF THE INVENTION

Nowadays there are lots of products available which can be controlled wirelessly, whether it is via a smart device (phone, tablet, PC, etc.,) or via another wireless device (remote control, wall switch, sensor, etc.,). Unlike for wired systems, where the connection is provided by the cabling itself, wireless devices need to be linked or associated with each other, to ensure that the communication does not involve third parties and a clear identification of all elements in the network is possible. This linking is normally referred to as pairing or commissioning of the devices.

Commissioning is a process of configuring nodes in a network so that they can communicate data to each other. At its most basic, and in the absence of any other configuration information, a fresh device will join the first network that offers itself. After joining, it “digests” information until it arrives at its stable operational state.

For commissioning, at least two devices are necessary. One or more devices that want to be wirelessly linked to an existing network and one controlling device which has the relevant information (credentials) of that network and provides it to the new devices. For new devices to join the network, both parties need to be triggered (to accept joining a new network and to accept providing the credentials of such network respectively). Once the controlling device adds the new devices to its network, the commissioning process should be stopped.

For a wirelessly controlled device that can be commissioned to a remote control of a network or for the remote control device itself, it needs to be possible to be reset so that it can be commissioned again, possibly to another remote control device or another setting. However, conventional wirelessly controlled electronic devices or remote control devices need external buttons or switches or the like for resetting or re-commissioning. It would be desirable to dispense with such additional external manual control elements.

### SUMMARY OF THE INVENTION

It is an object of the present invention to provide a method and apparatus for allowing commissioning of an electronic device in a controlled and secure manner, while later reconfiguration is possible without any external control elements.

This object is achieved by an apparatus as claimed in claim 1, by an electronic device as claimed in claim 6, and by a method as claimed in claim 9.

Accordingly, by the proposed resetting mechanism, commissioning can be done on a repetitive basis, such that the system and/or the controlled device can be reconfigured at a later time if needed, such that no unwanted or foreign elements need to join the network while doing so. Moreover, the proposed solution provides a resetting option which does not require any additional external buttons or the like.

As an additional advantage, commissioning control of the device is exclusive, as control over commissioning can only be obtained after resetting and powering the device or after first powering, wherein resetting can be done by the mechanical movement and thus with power in off state.

The use of the bi-stable element allows a mechanical change from a first stable position or state to a second stable position or state, without any electrical power needed. After successful commissioning, the bi-stable element is set to the first state by electronic control. Commissioning is also allowed when the device memory is empty, independent of the status of the bi-stable element. This assures that commissioning always starts when the controlled device leaves the factory after manufacturing. The mechanical movement can be done in the non-powered or off state and is needed to change the bi-stable element to the second state and to assure exclusive control since no one else can change the device status via remote control.

According to a first option, the electronic device may be a lighting device for commissioning to a lighting network. Thereby, lighting devices can be reconfigured at power-off state by a simple mechanical movement, such as a shake-to-reset movement.

According to a second option that can be combined with the first option, the control unit may be adapted to monitor the state of the bi-stable element alter power supply of the electronic device is switched on and to open the electronic device for commissioning in response to a detection of the second state or when the non-volatile memory is empty. Thus, after an intermediate non-powered state, the control unit can detect, based on the state of the bi-stable element, whether the electric device had been reset by the mechanical movement, so that the information about the state of the bi-stable element does not get lost.

According to a third option that can be combined with at least one of the first and second options, the control unit may be adapted to store the commissioning information in the memory and to set the bi-stable element into the first state after a successful commissioning procedure of the electronic device. Thus, after an intermediate non-powered state, the control unit can detect, based on the state of the bi-stable element and the content of the non-volatile memory, whether the electric device had been commissioned already, so that information about a previous commissioning does not get lost.

According to a fourth option that can be combined with any of the first to third options, the bi-stable element may comprise a mass element, a spring element and a snap element and may be adapted to be set into the second state by moving the mass element against the spring element until the snap element is brought into an engaged state. Optionally, the bi-stable element may then be adapted to be set into the first state by electronically disengaging the snap element in response to the applied control signal. Such an example of the mechanical structure of the bi-stable element allows an easy and straight forward implementation where the mechanical movement can be generated by simply shaking the electronic device.

It shall be understood that the apparatus of claim 1, the electronic device of claim 7, and the method of claim 9 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of a wireless electronic device according to a first embodiment;

FIG. 2 shows a flow diagram of control procedure after manufacturing of the wireless electronic device;

FIG. 3 shows a flow diagram of a control procedure after successful commissioning of the wireless electronic device; and

FIG. 4 shows a sequence of states of an exemplary bi-stable element according to a second embodiment.

### DETAILED DESCRIPTION OF EMBODIMENTS

The following embodiments are directed to a remotely controllable electronic device that can be commissioned in a network for remote control. As a non-limiting example, the electronic device of the present embodiments is a lighting device which can be wirelessly controlled by a remote control function of a lighting network.

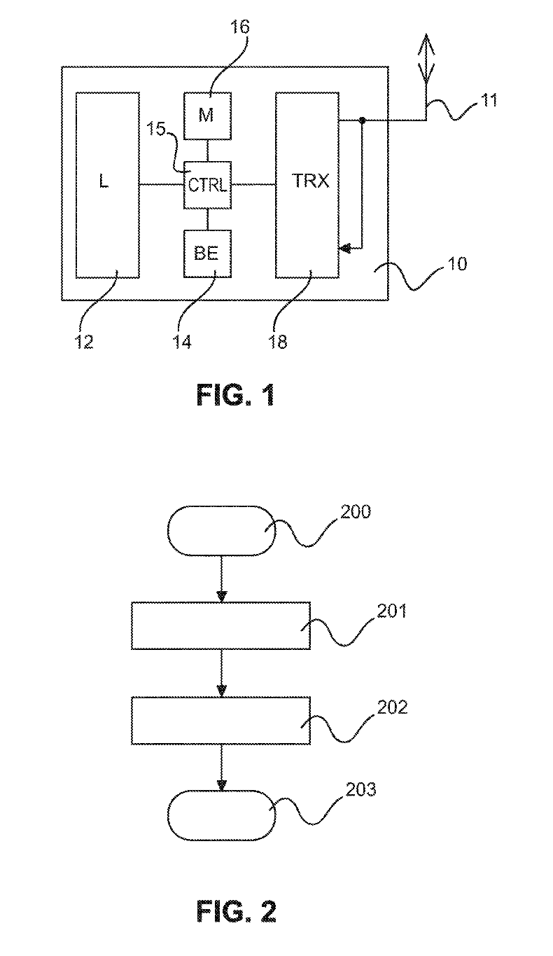

FIG. 1 shows a schematic block diagram of a wireless electronic device 10 according to a first embodiment. The block diagram shows only those components which are useful for describing the present invention. Other components have been omitted for brevity reasons.

According to FIG. 1, the electronic device 10 comprises a transceiver (TRX) circuit 18 for transmitting and receiving a radio frequency (RF) signal via at least one antenna element 11. The TRX circuit 18 is connected to a control unit 15 which is adapted to control at least one of an on-off state, brightness, directivity, color or the like of a lighting element (L) 12 based on a corresponding remote control information received from the lighting network via the antenna element 11 and the TRX circuit 18. Furthermore, the control unit 15 which may be a processor device or the like is adapted to read and write information into a non-volatile memory (M) 16 which may be a flash memory, an electrically erasable programmable read-only memory (EEPROM) or the like. Additionally, the control unit 15 is connected to a bi-stable element 14 which can be set into a first stable state and a second stable state. The control unit 15 is adapted to monitor the states of the bi-stable element 14 and to detect the current state the bi-stable element 14.

In the present embodiments, the bi-stable element 14 has two stable equilibrium states, i.e., it can rest in either of the two states. These rest states need not be symmetric with respect to stored energy. A transition from the first state to the second state thus requires some form of activation energy to exceed or overcome a barrier. There is no way back, i.e., a snap/click, only when the barrier is removed or released for some time. After the barrier is released, the system will relax into the first state of lower energy again.

In the design of a mechanical system work is done on or energy is applied to the system to move it just past the peak, at which point the mechanism goes “over centre” to its secondary stable position. The result is a toggle-type action where work applied to the system below a predetermined threshold sufficient to send it “over centre” results in no change of the state. Springs are a common method of achieving an “over centre” action.

The bi-stable element 14 according to the embodiments is arranged in a manner that it is initially in the lower-energy state, which is the first state, and can be set into the higher-energy state, which is the second state, by a mechanical movement required to apply external energy so as to move the bi-stable element 14 past the peak, at which point the mechanism goes “over centre” to the second state. As an example, the transition to the second state may be achieved by compressing a spring via the mechanical movement until it is fixed in compressed state by a snap or engagement mechanism. Transition from the second state to the first state is then achieved by having the control unit 15 apply an electric control signal so as to release the snap or engagement mechanism (e.g., by an electromechanical or electromagnetic force), which results in a release of the compressed spring. Due to the fact that the second state is maintained by a mechanical engagement operation, it is even kept and mechanically stored when power supply of the electronic device 10 is switched off. Any suitable bi-stable mechanism with the above characteristics can be used for the bi-stable element 14, so that the bi-stable element 14 can be set into the second state by a mechanical movement of the electronic device 10 (even in a power-off state) and can be set to the first state by means of an electric control.

The electronic device 10 of the first embodiment is configured as a remote controllable electronic device, wherein the non-volatile memory 16 is used for storing commissioning information required for commissioning the electronic device 10 to a remote controller. More specifically, the electronic device 10 is configured to allow or to be open to commissioning when the non-volatile memory 16 is empty, which is checked by the control unit 15. The control unit 15 writes the commissioning information into the non-volatile memory 16 after successful commissioning. Furthermore, the control unit 15 is adapted to use the bi-stable element 14 as a control element to open (or allow) the electronic device 10 for commissioning when it is in its second state (e.g. “0” state).

Thus, the wireless controlled device 10 can be initially commissioned to a remote control device when its non-volatile memory 16 is empty, and can be later reset by the bi-stable element 14 so that it can be commissioned again, possibly to another remote control device or to another setting. Due to the fact that the transition from the initial first state (e.g. “1” state) to the second state (“0” state) is achieved by a mechanical movement, no additional external button(s) is/are required. The bi-stable element 14 that can be mechanically changed from state “1” to state “0”, without electrical power needed. When in the second state “0” and the device powered on, commissioning can start and after successful commissioning the bi-stable element is set to the first state “1” again, e.g., by software and/or electronic control of the control unit 15. Commissioning is also allowed by the control unit 15 when it detects that the non-volatile memory 16 is empty, independent of the state of the bi-stable element 14. This assures that commissioning always starts when the electric device 10 is newly delivered from the factory and installed. The mechanical movement needed to change the bi-stable element 14 assures that no one else can change the device status via remote control and therefore assures exclusive control. As already mentioned, resetting to the second state can be done during the power-off or non-powered state.

It is noted that a similar control functionality with the bi-stable element 14, the non-volatile memory 16 and the control unit 15 can be provided for controlling commissioning at a remote control device which controls the controlled electronic device 10.

FIG. 2 shows a flow diagram of a control procedure for allowing/opening and blocking/closing the electronic device 10 for commissioning after manufacturing thereof, where successful commissioning also triggers the bi-stable element 14 to be set into the first state “1”.

When the electronic device is newly received from the factory, its non-volatile memory 16 is empty in step 200. In step S201, the control unit 15 detects the empty memory 16 and controls the electronic device 10 to be open for commissioning to a remote controller, when the device is powered. Then, in step 202, after successful commissioning, the commissioning information is permanently stored by the control unit 15 into the non-volatile memory 15 and the bi-stable element is set into the first state “1”, and the procedure ends in step 203.

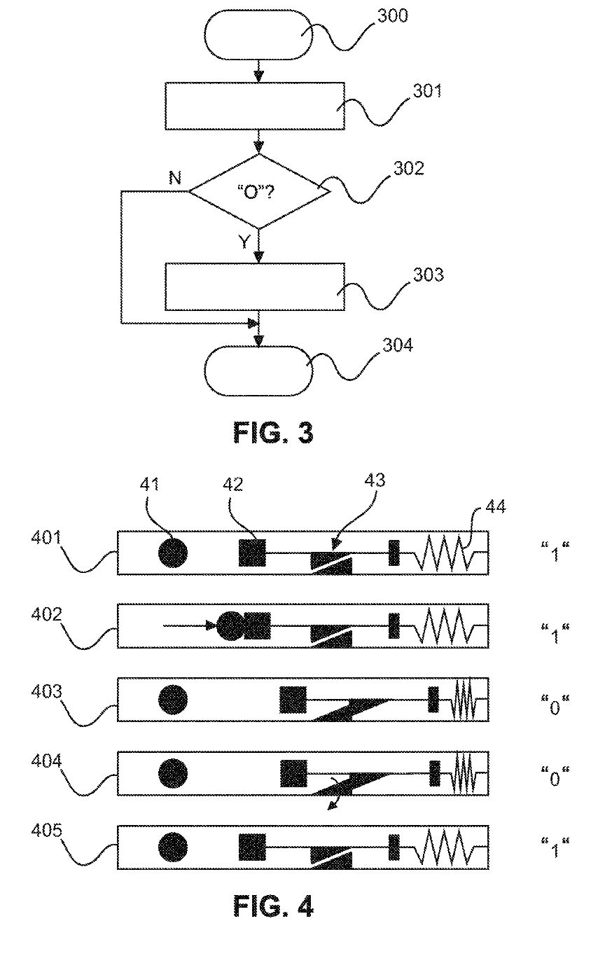

FIG. 3 shows a flow diagram of a control procedure for opening and closing the electronic device 10 for (re-)commissioning after successful commissioning of the wireless electronic device.

After power off and on again in step 300, the electronic device 10 is not open for commissioning as its non-volatile memory 16 is filled with commissioning information and the bi-stable element is set into its first state “1”. Then, e.g., after power off, a mechanical movement of the electronic device 10 in step 301 sets the bi-stable element 14 into the second state “0”.

Then, e.g., when powered-on again, the procedure of the control unit 15 checks in step 302 whether the bi-stable element 14 is set into the second state “0”. If so, the procedure proceeds to step 303 and the detected second state “0” opens the electronic device 10 for commissioning and the procedure ends with step 304. Otherwise, if the control unit 15 detects the first state “1”, no action is applied and the procedure jumps to step 304 and ends there, so that the electric device 10 is not opened for commission.

FIG. 4 shows a sequence of momentary states of a specific exemplary bi-stable element according to a second embodiment. The bi-stable element has a cylindrical shape and comprises a moveable ball-shaped mass element 41 that can freely move along the longitudinal axis of the bi-stable element. Furthermore, the bi-stable element comprises a plunger element with a widened impact portion 42 against which the mass element 41 can move by the mechanical movement (e.g. shaking) of the bi-stable element (e.g., a spring and snap element. Additionally, the plunger element comprises a snap element 43 which can be engaged with a corresponding counterpart at the inner wall of the cylindrical housing of the bi-stable element. Finally, the bi-stable element comprises a spring 44 that can be compressed by a longitudinal movement of the plunger element towards the spring 44.

In the first momentary state 401 of FIG. 4, the mass element 41 is located away from the plunger element and the bi-stable element is in its lower-energy first stable state “1”. Then, in the second momentary state 402 of FIG. 4, the mass element is accelerated along the arrow in FIG. 4 by external energy supplied by a mechanical movement of the bi-stable element and hits the impact portion 42 of the plunger element. Thereby, the plunger element is pressed against the spring 44 until the snap element 43 engages with the counterpart at the inner wall of the housing of the bi-stable element. Here, the second stable state “0” is reached, which is shown in the third momentary state 403 of FIG. 4. Then, in the fourth momentary state 404 of FIG. 4, a control signal is applied by the control unit 15 after successful commissioning and the counterpart of the snap element 43 is retracted by an electromechanical or electromagnetic force generated by the control signal, so that the spring 44 is released and the plunger moves back in the longitudinal direction until the first stable state “1” is reached again, as shown in the fifth momentary state 405 of FIG. 4.

Thus, a simple bi-stable mechanism can be used for implementing the bi-stable element. Of course, the present invention is not limited to this specific kind of bi-stable element. Various other options are readily available to the skilled person.

To summarize, the present invention relates to a method and an apparatus for resetting an electronic device using a bi-stable element that can be set into a first state by means of electronic control and into a second state by means of a mechanical movement while the electronic device can be in a non-powered state. Thus, after power off, the mechanical movement can be used to reset the bi-stable element into the second state which may open the electronic device for commissioning in a network.

The above embodiments can be applied in any wireless control systems (office, retail, home and others) with wireless controlled devices (e.g. switches, sensors or controls, building control systems with wireless sensors (temperature, presence, humidity, light level, etc.), or any other IP-based system with sensing or control or load devices. For example, future outdoor lighting systems based on IP networking.

Other variations to the disclosed embodiments can be understood and effected by those skilled in the art in practicing the claimed invention, from a study of the drawings, the disclosure, and the appended claims. In particular, it is not essential that the mechanical movement of the electric device is done in the power-off state and that the control unit checks the status of the bi-stable element status when the electric device (e.g. the lamp) is switched on again. As an alternative, it is possible to do the mechanical movement in the power-on state of the electric device and monitor the status of the bi-stable element every predetermined number of seconds. As another alternative, it is also possible to do the mechanical movement in the power-on state of the electric device and then switch off and on again.

Any processing and/or control functions of the control unit 15 (e.g. as indicated in FIGS. 2 and 3) can be implemented as program code means of a computer program and/or as dedicated hardware.

In the claims, the word “comprising” does not exclude other elements or steps, and the indefinite article “a” or “an” does not exclude a plurality.

A single processor or other unit may fulfill the functions of several items recited in the claims. The mere fact that certain measures are recited in mutually different dependent claims does not indicate that a combination of these measures cannot be used to advantage.

1. A reset apparatus of an electronic device for controlling a reset operation of said electronic device said reset apparatus comprising:
a bi-stable element adapted to be set into a first state in response to an applied electric control signal and to be set into a second state in response to a mechanical movement of the bi-stable element, wherein the mechanical movement of the bi-stable element is generated by shaking the electronic device;
a non-volatile memory for storing commissioning information when the electronic device is commissioned to a network; and
a control unit for applying the electric control signal in order to set the bi-stable element into the first state when the commissioning information is stored in the non-volatile memory;
wherein the control unit is adapted to allow the electronic device to be commissioned when the bi-stable element is in the second state and to block the electronic device from commissioning when the bi-stable element is in the first state.

2. The apparatus according to claim 1, wherein the control unit is adapted to monitor the state of the bi-stable element after power supply of the electronic device is switched on and to allow the electronic device to be commissioned in response to a detection of the second state or when the non-volatile memory is empty.

3. The apparatus according to claim 3, wherein the control unit is adapted to store the commissioning information in the non-volatile memory and to set the bi-stable element into the first state after a successful commissioning procedure of the electronic device.

4. The apparatus according to claim 1, wherein the bi-stable element comprises a mass element, a spring element and a snap element and is adapted to be set into the second state by moving the mass element against the spring element until the snap element is brought into an engaged state.

5. The apparatus according to claim 5, wherein the bi-stable element is adapted to be set into the first state by electronically disengaging the snap element in response to the applied control signal.

6. An electronic device comprising an apparatus according to claim 1.

7. The electronic device according to claim 6, wherein the electronic device is a lighting device to be commissioned to a lighting network.

8. The electronic device according to claim 6, wherein the electronic device is a wirelessly controllable device or a remote control device.

9. A method of controlling a reset operation of an electronic device, said method comprising:
storing commissioning information in a non-volatile memory when the electronic device is commissioned to a network;
applying an electric control signal in order to set a bi-stable element into a first state when the commissioning information is determined to be stored in the non-volatile memory.
setting the bi-stable element into a second state in response to a mechanical movement of the bi-stable element, which mechanical movement is generated by shaking the electronic device; and
allowing the electronic device to be commissioned when the bi-stable element is in the second state or when the non-volatile memory is empty, and blocking the electronic device from commissioning when the bi-stable element is in the first state.

10. The method according to claim 9, further comprising providing the non-volatile memory in an empty state when the electronic device is manufactured.

11. The method according to claim 9, storing the commissioning information in the non-volatile memory and applying the control signal to the bi-stable element after successful commissioning of the electronic device.
